(19) United States
(12) Patent Application Publication
(10) Pub. No.: US 2025/0272118 A1
(43) Pub. Date: Aug. 28, 2025

(54) DYNAMIC WORKFLOW ENGINE FOR ACTION GENERATION AND SENSING

(71) Applicant: Clari Inc., Sunnyvale, CA (US)

(72) Inventors: Harvey Chui, Sydney (AU); Andrew Elliott, Salt Lake City, UT (US); Craig Volonoski, San Carlos, CA (US); Vijay Pemmaraju, San Diego, CA (US); Jin Huang, Danville, CA (US); Zac Brown, San Diego, CA (US); Larry Pelty, Houston, TX (US); Austin Wang, Seattle, WA (US); Chris Rothstein, San Diego, CA (US)

(21) Appl. No.: 18/589,499

(22) Filed: Feb. 28, 2024

(51) Int. Cl. G06F 9/451

(52) U.S. Cl. CPC G06F 9/451

(57) ABSTRACT

A method includes displaying a user interface that includes one or more controls for identifying one or more records of a remote data platform, for generating one or more conditions associated with the one or more records, and for generating an action that is associated with the one or more conditions. Input is received through the user interface that identifies the one or more records and defines the one or more conditions and the action. The method determines a user associated with the action, senses device activity of the user, and senses the one or more records on the remote data platform for satisfaction of the one or more conditions. In response to sensing non-performance of the action and in response to sensing the one or more records on the remote data platform satisfy the one or more conditions, the action is provided to the user.

### TECHNICAL FIELD

Embodiments of the present disclosure relate generally to a data processing system and more particularly, embodiments of the disclosure relate to dynamic workflow engine for action generation and sensing.

### BACKGROUND

Data processing systems may include computer readable memory that stores machine executable instructions that can be performed by a processor. The instructions may be grouped together in terms of functionality to what is referred to as an application. Applications may be stored and performed locally at a user's machine, or they may be performed by remotely by a data processing system over a computer network, in what may be referred to as a cloud-based application. Data processing systems on computer networks (e.g., the internet) provide a variety of services to users.

### BRIEF DESCRIPTION OF THE DRAWINGS

Embodiments of the disclosure are illustrated by way of example and not limited to the figures of the accompanying drawings in which like references indicate similar elements.

FIG. 1 shows an example of a data processing system that includes a dynamic workflow engine, in accordance with an embodiment.

FIG. 2 illustrates an example method for evaluating a formula from a remote data system, in accordance with an embodiment.

FIG. 3 shows a diagram of operations that may be performed by a dynamic workflow engine, in accordance with an embodiment.

FIG. 4 shows an example timeline of generating and implementing a workflow sensing item, in accordance with an embodiment.

FIG. 5 shows an example of one or more records for managing a workflow sensing item, in accordance with an embodiment

FIG. 6 is a block diagram illustrating an example of a data processing system which may be used with one embodiment.

### DETAILED DESCRIPTION

Computing devices may be accessible over a computer network to provide one or more services. This may be referred to as cloud computing, in which these computing devices provide on-demand access to computing resources over the internet. Such service includes servers, data storage, applications, networking, email, etc. Cloud computing may be available to the public (e.g., public cloud), on a private network (e.g., private cloud), or a hybrid thereof.

Public clouds deliver resources, such as compute, storage, network, develop-and-deploy environments, and applications over the internet. They may be owned and run by third-party cloud service providers. Private clouds are built, run, and used by a single organization, typically located on-premises. They provide greater control, customization, and data security but come with similar costs and resource limitations associated with traditional IT environments. Environments that mix at least one private computing environment (traditional IT infrastructure or private cloud, including edge) with one or more public clouds are called hybrid clouds. They provide resources and services from different computing environments and choose which is suitable for given applications. For cloud deployments, different service frameworks exist. These include, for example, infrastructure as a service (IaaS), platform as a service (PaaS), software as a service (SaaS), and server-less computing.

In some use cases of cloud computing, networked servers can store records that are structured to convey sales-based data. Such networked servers may provide coordinated functionality in what may be referred to as a data platform, or more specifically, a customer relationship management (CRM) tool. For example, a data platform may manage one or more records that store information relating to a sales target which may be a party of interest that a user wishes to engage and interact with to potentially conduct business with. The information may include various fields that indicate events (e.g., meetings, conferences, etc.), dates, people within the sales target organization, outreach goals (e.g., emails, meetings, phone conferences, etc.) to help a sales team manage their outreach and interactions with the sales target. The data platform may comprise API for users (e.g., sales teams) to connect with these records and perform typical operations such as to read from, write to, and search these records.

A data platform (e.g., a CRM tool) may include a plurality of computing devices that manage a party's interactions with customers and potential customers. Data platforms can help the party build customer relationships, improve customer service, increase sales, and increase profitability. Data platforms can help manage sales, provide actionable insights, and integrate with other platforms.

Even with such a tool, an organization (or sales team thereof) may face challenges with respect to efficiently managing their outreach, tracking interactions, and personalizing their communications in a precise manner. Traditional cloud computing systems (e.g., traditional CRM tools) may not provide the flexibility and functionality for dynamic sales engagement, which may lead to missed opportunities and inefficiencies.

Aspects of the present disclosure provides a system (or method) that obtains data from a remote data system (e.g., a CRM tool), matches that data to specific conditions, and based on that analysis produces an executable action for the user. The system provides customizability beyond that of existing systems, by combining both standard and custom objects and fields with conditions to direct an action. The system may combine disparate sources of data (e.g., from different data platforms) to provide actionable insights to improve performance. The system may integrate directly with multi-channel communication such as, for example, email, calls, Short message Service (SMS), or third party platforms (e.g., LinkedIn, Sendoso, etc.) to provide actionable controls to a user when one or more conditions are satisfied. The system may enable an operator to program a unique strategy which may be stored by the system. The system may sense the progress of the strategy and may store events related to the strategy. The system provides a way for users to understand if the strategy is complete with the intended outcome and whether the user needed a notification to perform the action and complete the strategy.

In an aspect of the present disclosure, a system comprises one or more computing devices, configured to perform operations comprising presenting a user interface that includes one or more controls. The one or more controls (e.g., buttons, input fields, selectable lists, etc.) are configured to identify one or more records of a remote data platform. Further, the controls are configured to generate one or more conditions associated with the one or more records, and to generate an action that is associated with the one or more conditions. The system may receive input through the user interface that identifies the one or more records and defines the one or more conditions and the action. The system may determine a user associated with the action, sense device activity of the user, and sense the one or more records on the remote data platform for satisfaction of the one or more conditions. In response to sensing non-performance of the action and in response to sensing the one or more records on the remote data platform satisfy the one or more conditions, the system provides the action to the user for the user to perform.

In an embodiment, determining the user (to receive the action) comprises searching one or more fields of the one or more records or metadata associated with the one or more records and finding an association of the user to the one or more records. Additionally, or alternatively, determining the user comprises receiving indication of the user from the input through the user interface.

In an embodiment, presenting the one or more controls comprises presenting selectable fields and selectable operators to generate the one or more conditions. In an embodiment, presenting the one or more controls comprises determining one or more actions based on fields of the one or more records or metadata that is associated with the one or more records, and presenting the one or more controls for selecting the action among one or more actions for an operator of the user interface to select from based on the one or more records. The controls may be determined dynamically based on the one or more records.

In an embodiment, receiving the one or more conditions comprises receiving a machine executable script comprising a query into the one or more records. In an embodiment, providing the action to the user comprises at least one of: displaying a first instruction or control to the user to send an email to send to a second user; displaying a second instruction or control to make a phone call to send to the second user; displaying a third instruction or control to connect with the second user over a social network; displaying a fourth instruction or control to send a short message service (SMS) message to the second user, or displaying a fifth instruction or control to send a message to the second user with a third party messaging platform. In an embodiment, the second user is determined based on one or more fields or metadata of the one or more records or is indicated in the input through the user interface.

In an embodiment, sensing the device activity of the user comprises using one or more application plugins that sense operations associated with an email application, browser application, or a standalone application, to determine whether the action is performed by the user.

In an embodiment, in response to sensing that the action is performed by the user, the system refrains from providing the action to the user and stores in memory a second record that includes that the user performed the action prior to satisfaction of the one or more conditions.

In an embodiment, the one or more conditions comprise multiple conditions. For example, the one or more conditions may include a trigger condition to begin sensing the one or more records on the remote data platform. Additionally, the one or more conditions may comprise a time condition to perform the action within.

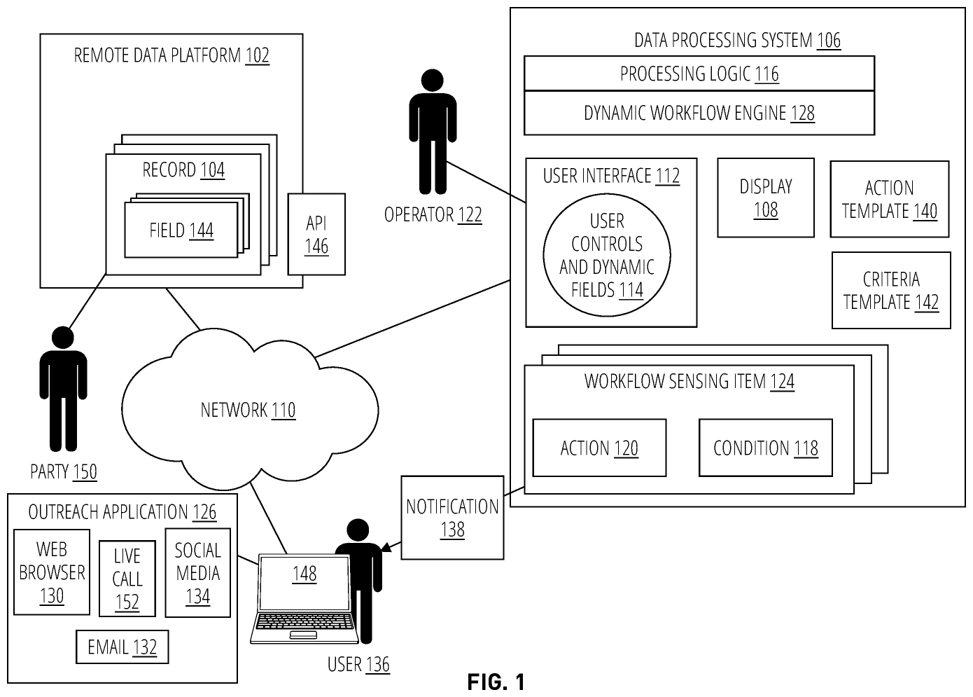

FIG. 1 shows an example of a data processing system 106 that includes a dynamic workflow engine 128, in accordance with an embodiment. Data processing system 106 may comprise a single computing device, or a plurality of computing devices, such as computing device computing device 600.

Data processing system 106 may comprise processing logic 116 which may include hardware (e.g., a processing device, computer-readable memory, transmitter, receiver, power supply, transmission lines, communication buses, etc.) and software (e.g., machine executable instructions stored on computer-readable memory) that is configured to perform the described functionality of dynamic workflow engine 128. Dynamic workflow engine 128 may present a user interface 112 to an operator 122. The user interface 112 may be displayed as a graphical user interface on a display 108. The user interface includes one or more controls (e.g., buttons, input fields, selectable lists, etc.) for identifying one or more records 104 of a remote data platform 102.

The remote data platform 102 and data processing system 106 may be communicatively coupled to a network 110. Network 110 may represent a plurality of computers in wired or wireless communication with each other using one or more communication protocols (e.g., TCP/IP, Wi-fi, long-term evolution, new radio, etc.).

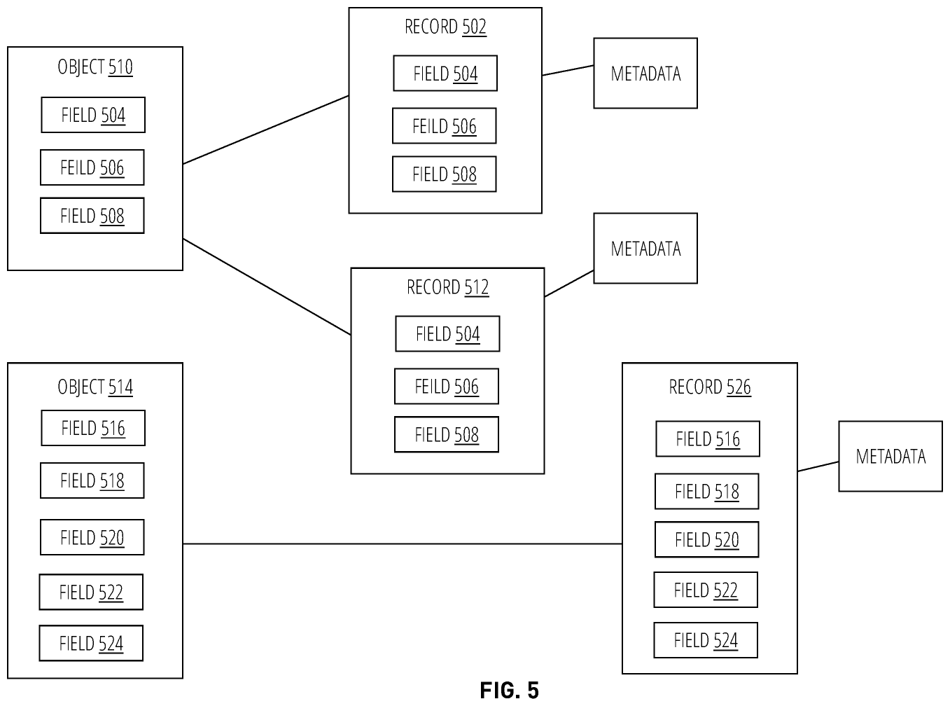

Remote data platform 102 may comprise a plurality of computing devices that store and manage records 104 which may be associated with different parties (e.g., party 150) and store different types of information depending on the underlying body type. This is described further with respect to FIG. 5. In an embodiment, remote data platform 102 may comprise a CRM tool such as, for example, Salesforce or another CRM tool.

The user interface 112 may comprise one or more screens with a button, selectable list, or input field for operator 122 to indicate one or more parties (e.g., one or more customers, potential customers, or accounts of interest). Based on the targeted party 150, data processing system 106 may determine which records on remote data platform 102 are associated with the target (e.g., by querying the remote data platform 102 through an application programming interface API 146).

In an embodiment, presenting the one or more controls 114 comprises presenting selectable fields and/or selectable logical operators to generate the one or more conditions 118. Dynamic workflow engine 128 may generate one or more conditions 118 that are associated with the one or more records 104. For example, dynamic workflow engine 128 may receive input through the one or more user controls and dynamic fields 114 to select which of the one or more fields 144 in the one or more records 104 are to be conditioned upon. Further, dynamic workflow engine 128 may receive input from operator 122 that defines one or more logical operators that are associated with selected fields. For example, operator 122 may input that condition 118 is satisfied “If ‘Field A’ value≥ ‘X’ or ‘Field B’ value≠‘Y’”. This condition 118 may be generated and stored in memory as a data object represented by workflow sensing item 124. The one or more conditions 118 may comprise a trigger that may indicate an event (e.g., an email, a meeting, a demonstration, a call, etc.) that starts monitoring or sensing associated with a workflow sensing item 124, an intended close date which may be predicated on the trigger, one or more sentiments or labels associated with an event (e.g., a call or meeting), a deal size or amount, number of contacts, title of the contacts (e.g., chief officer, director, associate, buyer, etc.), email activity, a contractual milestone, etc. In an embodiment, workflow engine 128 may obtain potential conditions from criteria template 142, and present them as options for operator 122 to select one or more conditions 118 through user interface 112.

In an embodiment, receiving the one or more conditions 118 comprises receiving a machine executable script (e.g., with an agreed upon convention or computer language). The script may comprise one or more queries into the one or more records 104, which may leverage calls through API 146.

Dynamic workflow engine 128 may generate an action 120 that is associated with the one or more conditions. This action 120 may comprise an outreach action (e.g., sending an email, a phone call, a video conference call, sending a message on a web-based platform, etc.) to a party 150 that is associated with the one or more records 104. A user may input a definition of action 120 through the user interface 112 that is to be performed. In an example, the dynamic workflow engine 128 may use action template 140 which may comprise a plurality of potential actions that operator 122 wants to make user 136 responsible for performing. Dynamic workflow engine 128 may display a selectable list of actions from the action template 140 through the user interface 112, for operator 122 to select from. Dynamic workflow engine 128 may determine one or more potential actions based on fields of the one or more records or metadata that is associated with the one or more records.

For example, if the record is of type ‘Opportunity’, then dynamic workflow engine 128 may present actions ‘X, Y, and Z’ as potential actions. If the record 104 is of type ‘Account’, then dynamic workflow engine 128 may present actions ‘W and X’. The dynamic workflow engine 128 may dynamically configure the one or more controls 114 to present the selectable actions that tailored for a given record 104 (e.g., based on type, or party 150, or other information). Operator 122 may select from among the available action to generate workflow sensing item 124.

Through the user interface 112, the operator 122 identifies the one or more records 104 and defines the one or more conditions 118 and the action 120 that the dynamic workflow engine 128 saves as a workflow sensing item 124. Workflow sensing item 124 may be referred to as a ‘play’ that defines one or more conditions 118 and at least one action 120 for a user 136 to perform. Each workflow sensing item 124 is related to a party 150 (e.g., a customer or potential customer), and more particularly, to a desired outcome with the party 150, to manage interaction between the user 136 and that party 150. In an aspect, dynamic workflow engine 128 may generate and sense activity related to a plurality of workflow sensing items. For each workflow sensing item, dynamic workflow engine 128 may activate a separate processing thread to perform the sensing and notification associated therein.

In an embodiment, dynamic workflow engine 128 may determine the user 136 that is associated with the action 120. Determining the user 136 (to receive the action) may include searching one or more fields of the one or more records or metadata associated with the one or more records and finding an association of the user to the one or more records. For example, a record may indicate that user 136 attended a meeting or is a point of contact associated with record 104. Each record may correspond to a specific target party (e.g., party 150). Additionally, or alternatively, determining the user comprises receiving indication of the user 136 through the user interface. For example, operator 122 may specify the user 136 that is to receive the action 120. In an example, the dynamic workflow engine 128 may parse metadata associated with record 104 to determine that user 136 is associated with record 104. In an example, dynamic workflow engine 128 may parse the fields of record 104 to select a best candidate to contact party 150 (e.g., user 136 attended a physical or virtual event associated with party 150, or user 136 is a responsible for party 150). Dynamic workflow engine 128 may digitally store user 136 and information associated with that user (e.g., login information, a digital token to contact the user through an application, an email address, a phone number, etc.,) as being associated with workflow sensing item 124. Dynamic workflow engine 128 may use this information to provide the notification 138.

For each workflow sensing item 124, dynamic workflow engine 128 may sense device activity of the respective user 136 (to which the action 120 is to be performed by) and sense the one or more records 104 on the remote data platform. Based on the dynamically updated data of the one or more records 104, dynamic workflow engine 128 may sense whether the one or more conditions 118 are satisfied.

For example, workflow sensing item 124 may be associated with user 136. Dynamic workflow engine 128 may sense the device activity of the user 136 (e.g., ingoing outgoing emails, messages sent by user 136 on third party messaging platforms such as LinkedIn, Sendoso, etc.). Dynamic workflow engine 128 may communicate with one or more application plugins or agents on the user device 148 to detect operations performed by user 136. User device 148 may represent a single device, or multiple devices operated by user 136. User device 148 may be communicatively coupled to network 110. In an embodiment, dynamic workflow engine 128 may sense operations associated with an email application, browser application, or a standalone application, to determine whether the action is performed by the user (e.g., whether the user has made a phone call, a video call, or has sent an email or other digital message to the party 150). A plugin (e.g., a software agent or secondary functionality) may be built into the email, browser, phone call application, video call application, or standalone application to send user activity to dynamic workflow engine 128 over network 110. In an embodiment, dynamic workflow engine 128 may send regular prompts to user 136 to receive input as to whether or not user 136 has performed one or more actions to determine if action 120 has been performed.

In response to sensing non-performance of the action 120 (e.g., user 136 has not sent an email, phone call, videocall, or other message to party 150), and in response to sensing the one or more records on the remote data platform satisfy the one or more conditions (e.g., ‘Y’ number of days since meeting on Jan. 2, 2022), dynamic workflow engine 128 provides the action 120 as specified in the workflow sensing item 124 to the user 136. This action 120 may be provided through a notification 138 which may be provided as a displayed message (e.g., in a notification window, in an email, etc.,), on a display of user device 148.

User device 148 may include one or more of a desktop computer, a laptop computer, a mobile phone, a tablet computer, a head up display, or other computing device which may correspond to computing device computing device 600. In an embodiment, the one or more conditions 118 comprises multiple conditions. For example, the one or more conditions may include a trigger condition (e.g., event occurred on June 13) to begin sensing the one or more records 104 on the remote data platform. Additionally, the one or more conditions may comprise a time condition to perform the action within (e.g., 14 days from the trigger of when the event occurred).

In an embodiment, providing the action to the user (notification 138) comprises at least one of: displaying a first instruction to the user to send an email to send to a second user; displaying a second instruction to make a phone call to send to the second user; displaying a third instruction to connect with the second user over a social network; displaying a fourth instruction to send a short message service (SMS) message to the second user, or displaying a fifth instruction to send a message to the second user with a third party messaging platform. Additionally, or alternatively, dynamic workflow engine 128 may present a control to the user in the notification 138. The control may comprise a button, a selectable field, etc., which may be integral to outreach application 126 or cause outreach application 126 to run on user device 148. In an example, dynamic workflow engine 128 may perform one or more calls to an operating system of user device 148 to open one of a web browser 130, a calling application 152 (e.g., for voice over IP, a video conference application, etc.) an email application 132, a social media application 134, or other outreach application 126 that may be used to send a message to (or call) party 150. Based on input of this control (e.g., a button press), the dynamic workflow engine 128 may directly call upon a respective outreach application 126 to open on user device 148. Additionally, or alternatively, the dynamic workflow engine 128 may automatically (e.g., without input from a human such as user 136) perform the action with respect to party 150 (e.g., send the email, SMS, a connection or message over third party platform such as a social network platform or Sendoso). In an embodiment, operator 122 may store a setting in workflow sensing item 124 that controls whether action 120 is to be sent to user 136, performed automatically, or performed automatically after one or more additional conditions 118 (for example, if user 136 does not perform the action 120 in ‘X’ days, perform action automatically). Dynamic workflow engine 128 may access action template 140 to generate action content (e.g., a subject and/or body of an email or message) and perform calls to one or more respective API to perform the action (e.g., an API of an email client, and API of a third party messaging platform, and API of a web-browser, etc.).

In an embodiment, in response to sensing that the action is performed by the user, the system refrains from providing the action to the user and stores in memory, a second record that includes that the user performed the action prior to satisfaction of the one or more conditions. For example, dynamic workflow engine 128 may sense that user 136 sent an email to party 150 prior to satisfaction of the one or more conditions 118, and in response, store a second record indicating that user 136 sent this email to party 150 without receiving notification 138. Dynamic workflow engine 128 may keep and store records associated with a plurality of parties and a plurality of different workflow sensing items. In an embodiment, dynamic workflow engine 128 may display data, a graph, or other visual representation indicating for a given workflow sensing item, whether the action was performed by the user with or without being provided a notification, and whether the action was eventually performed even after being provided the notification.

Aspects described with respect to FIG. 1 may correspond to a method performed by dynamic workflow engine 128. In some aspects, the operations may be stored as machine-executable instructions and stored in computer-readable memory (e.g., as an application).

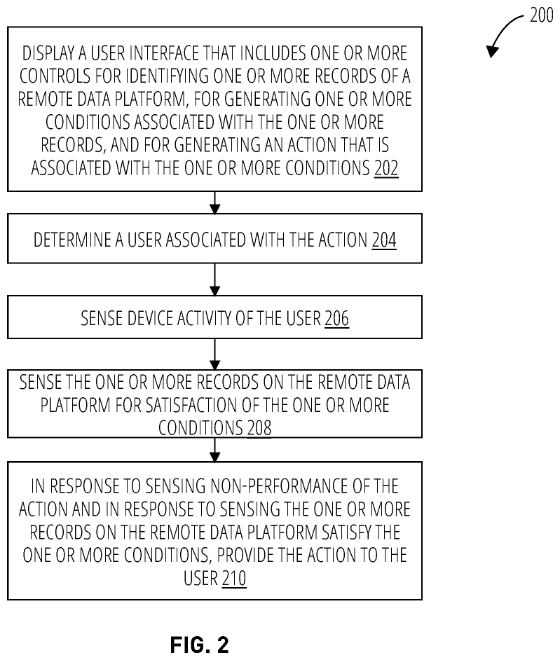

FIG. 2 illustrates an example method 200 for evaluating a formula from a remote data system, in accordance with an embodiment. The method may be performed by a dynamic workflow engine that is carried out by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof.

Method 200 illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in method 200 may be performed in an order different than presented, and that not all of the blocks in the method may be performed.

At block 202, processing logic displays a user interface that includes one or more controls for identifying one or more records of a remote data platform, for generating one or more conditions associated with the one or more records, and for generating an action that is associated with the one or more conditions. For example, processing logic may receive input as to one or more parties of interest. Processing logic may use an API of a remote data platform to search for and obtain the one or more records associated with the interested party. Processing logic may receive one or more conditions that include one or more fields of the one or more records, and logic associated with those field (e.g., if field A indicates meeting occurred, trigger sensing of other conditions such as if time since meeting occurred > ‘Y’ then condition is satisfied). In other words, processing logic may display a user interface that comprises one or more controls that are configured to receive input from a user and, based on that input, identify one or more records of a remote data platform, generate one or more conditions associated with the one or more records, and generate an action that is associated with the one or more conditions. The action is generated but not performed, rather it is stored and provided to a user if the condition is met, as described below.

At block 204, processing logic determines a user associated with the action. Processing logic may determine the user based on input by an operator, or based on searching the one or more records or metadata thereof, as described.

At block 206, processing logic may sense device activity of the user. As described, processing logic may communicate with plugins or an agent on a user device, to sense whether the user has digitally contacted the party of interest. Additionally, or alternatively, processing logic may receive input from the user that affirms that the user has contacted the party of interest.

At block 208, processing logic may sense the one or more records on the remote data platform for satisfaction of the one or more conditions. For example, processing logic may use an API to obtain the fields of the one or more records on the remote data platform, to determine if a triggering event has occurred, or if a time condition has been satisfied.

At block 210, in response to sensing non-performance of the action and in response to sensing the one or more records on the remote data platform satisfy the one or more conditions, processing logic may provide the action to the user. For example, processing logic may provide actionable controls to the user to run an application on the user's device. In an example, processing logic may automatically generate a message (e.g., an email with body text and subject, a message on a third party application, etc.) from a template provide this to the user with a control to modify the message and send the message. In an example, processing logic may automatically generate an invite at a specified time and provide this to the user with a control to send the invitation (e.g., a phone call or video conference call) to the party. If, however, processing logic senses that the action is performed by the user, processing logic may refrain from sending the notification, so that the user does not perform redundant outreach. Further, as described, processing logic may automatically perform the action without requiring user input, rather that providing them to the user, or after processing logic senses that the user has not performed the provided action after a threshold amount of time or after a predetermined date (which may be specified by the operator).

Operations described in the present disclosure as being performed ‘automatically’ may be referred to as being performed by processing logic without human input. Method 200 as well as other aspects of the present disclosure are automatically performed by processing logic (e.g., without human guidance or intervention), other than when human input is expressly indicated.

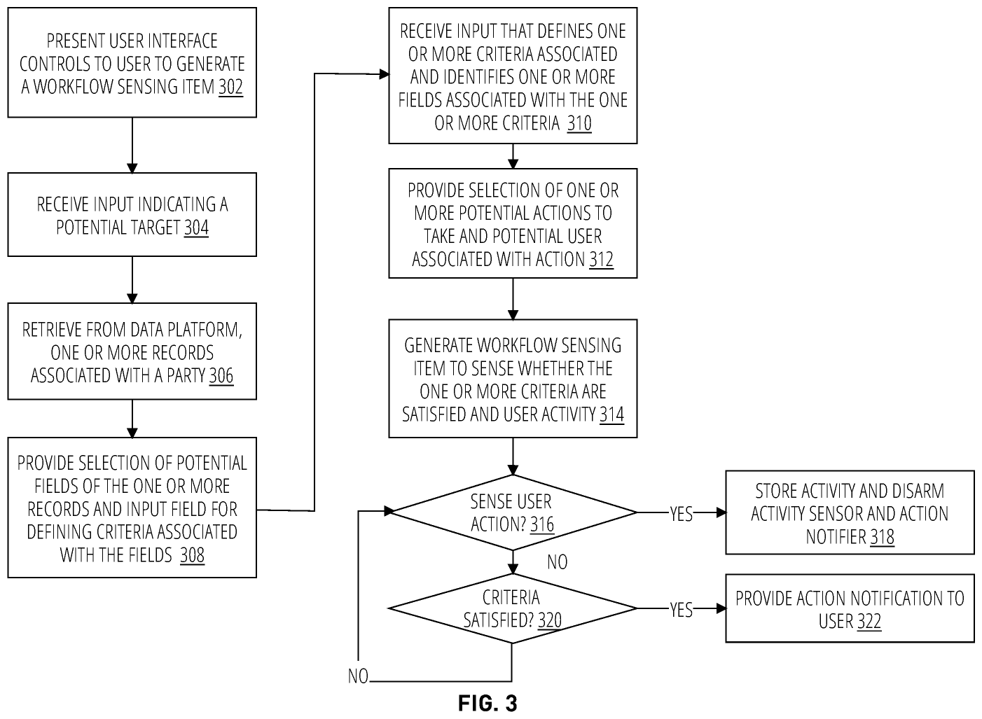

FIG. 3 shows a diagram of operations that may be performed by a dynamic workflow engine, in accordance with an embodiment. Although the diagram depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

At block 302, dynamic workflow engine presents a user interface controls to user to generate a workflow sensing item (comprising one or more conditions and an action). A workflow sensing item may also be referred to as a ‘play’. At block 304, dynamic workflow engine receives input indicating a potential target of the play (e.g., party 150). At block 306, dynamic workflow engine retrieves, from a data platform, one or more records associated with the party.

At block 308, dynamic workflow engine provides a selection of potential fields of the one or more records and input field for defining one or more conditions associated with the fields at block 308. These may include a text input field, a selectable list of records, fields, and/or logical operators, a button, etc.

At block 310, dynamic workflow engine receives input that defines one or more conditions associated and identifies one or more fields associated with the one or more conditions. At block 312, dynamic workflow engine provides (e.g., displays) a selection of one or more potential actions to take and one or more potential users that may be associated with action at block 312. The operator may select from among the potential actions and the potential users to perform the selected action.

At block 314, dynamic workflow engine generates the workflow sensing item to sense whether the one or more conditions are satisfied and to sense user activity. Each workflow sensing item may be generated to target a specific event or series of events to increase contacts with the party and to potentially enter a contractual agreement with the party. Dynamic workflow engine may manage a plurality of workflow sensing items at a given point in time, each of which may have separate dedicated resources (e.g., a dedicated processing thread, memory, etc.).

At block 316, dynamic workflow engine may sense user action to determine if the user has performed the action ahead of receiving a notification. This sensing may be performed continuously (e.g., periodically repeated). If dynamic workflow engine senses that the user has performed the action ahead of the notification, the dynamic workflow engine may proceed to block 318 and store this activity and disarm the workflow sensing item. In this case, the dedicated resources for that workflow sensing item may be released so that it may be reallocated to future items or general use. If dynamic workflow engine senses that the user has not performed the action, dynamic workflow engine proceeds to block 320.

At 320, dynamic workflow engine may monitor whether the one or more conditions are satisfied. This may include checking for satisfaction of the logical condition as input by the operator, and/or checking fields of the one or more relevant records. If the one or more conditions are satisfied, dynamic workflow engine may proceed to block 322 and provide the action notification to the user. As described, this notification may include one or more of a text-based message, a control, or an application, each of which being associated with performing outreach to the intended party.

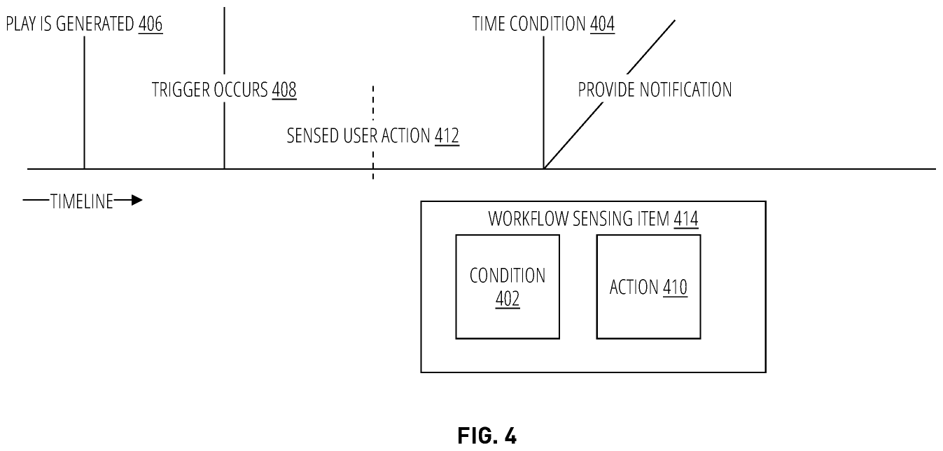

FIG. 4 shows an example timeline of generating and implementing a workflow sensing item 414, in accordance with an embodiment.

At time 406, a workflow sensing item 414 is generated. This may be generated as described, by a dynamic workflow engine. As described, workflow sensing item 414 may comprise one or more conditions 402, and one or more actions 410. One or more conditions 402 may comprise a triggering condition and other conditions (e.g., a time condition).

At time 408, dynamic workflow engine senses that a trigger occurs. For example, this trigger may be set as a time, or an event occurrence. At time 404, a condition (e.g., a time condition) is satisfied. For example, the satisfied condition at time 404 may be specified as being satisfied ‘X days’ after occurrence of the trigger condition.

If, at time 404, the dynamic workflow engine senses that the user has not performed the action 410, then dynamic workflow engine may provide a notification to the user. As mentioned, this sensing may be performed by sensing user activity of an application using a plugin, an agent, a log file, or other source indicating user activity of the application on a user device. If, however, the dynamic workflow engine senses that the user performed the action 410 at a time 412 prior to time 404, then the dynamic workflow engine refrains from sending the notification.

FIG. 5 shows an example of one or more records for managing a workflow sensing item, in accordance with an embodiment. A data platform may comprise objects (e.g., object 510, object 514). Objects and fields are analogous to database tables and the table columns. Objects and fields structure data with a desired format. An object may represent an account such as an organization, customer, competitor, etc. A remote data platform may comprise different types of objects with predetermined format (e.g., predetermined fields). Further, remote data platform may support customizable fields. Different object types may have different fields. For example, object 510 may comprise fields 504, 506, 508. Object 514 may comprise fields 516, 518, 520, 522, 524.

A record describes a particular occurrence of an object. For example, Organization A may be represented by a first record 502, and Organization B may be represented by a second record 512. The records 502 and 512 may be specific to different organization but have the same data format. A record is analogous to a row in a database table.

Each record or a particular combination of records may be informative to a specific workflow item, to increase contacts with a particular target in mind. For example, record 512 (e.g., of an account object type) and record 5266 (e.g., of an opportunity object type) may both be associated with the same target party. The dynamic workflow engine may generate a specific workflow sensing item (e.g., a ‘play’) to assign one or more conditions to one or more fields in record 512 and record 516. In such a manner, the dynamic workflow engine may monitor fields from multiple records to give actionable insights related to a particular play or target.

As described, one or more conditions of a workflow sensing item may comprise one or more of: a trigger that may indicate an event (e.g., an email, a meeting, a demonstration, a call, etc.) that starts monitoring or sensing associated with the workflow sensing item, an intended close date which may be predicated on the trigger, one or more sentiments or labels associated with an event (e.g., a call or meeting), a deal size or amount, number of contacts, title of the contacts (e.g., chief officer, director, associate, buyer, etc.), email activity, or a contractual milestone. Further, one or more of the fields of a record may carry the relevant information to determine satisfaction of the condition (e.g., the time of last email to the contact, the number of contacts, title of contacts, etc.). As such, a dynamic workflow engine may monitor the fields of a given record that are conditioned upon, in order to determine whether or not the one or more conditions of a workflow sensing item are satisfied.

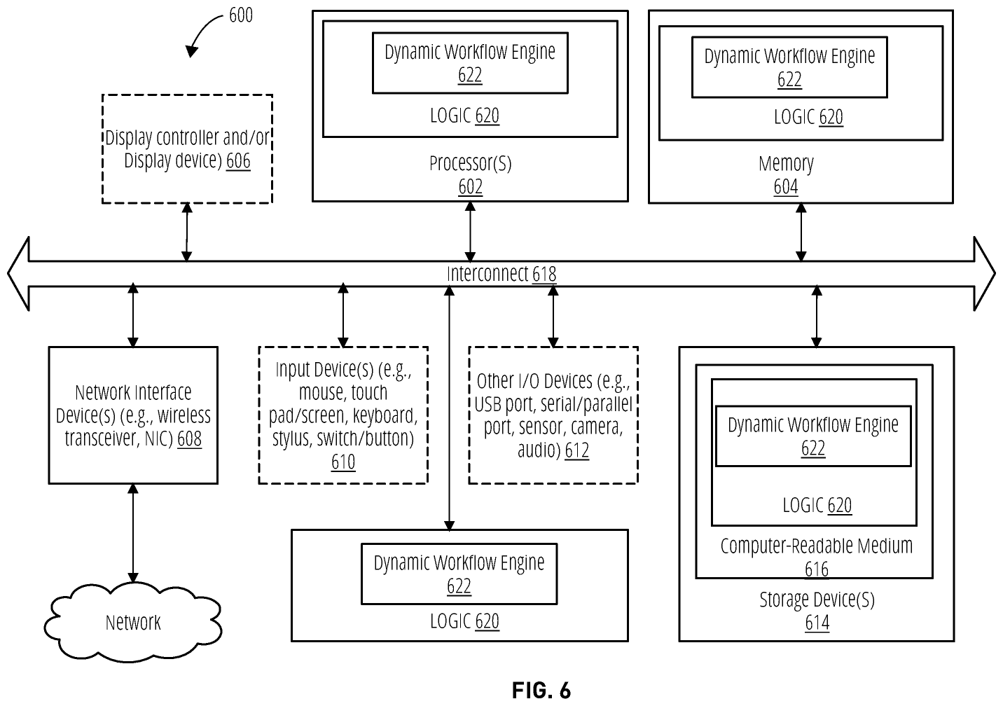

FIG. 6 is a block diagram illustrating an example of a data processing system which may be used with one embodiment. For example, system 600 may represent any of data processing systems described above performing any of the processes or methods described above, such as, for example, data processing system 106, remote data platform 102, and/or user device 148.

System 600 can include various different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 600 is intended to show a high level view of many components of the computer system. However, it is to be understood that additional components may be present in certain implementations and furthermore, different arrangement of the components shown may occur in other implementations. System 600 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 600 includes processor 602, memory 604, and additional components 608, 610, 612, 614, and 620 which may be coupled over a bus or an interconnect 618. Processor 602 may represent a single processor or multiple processors with a single processor core or multiple processor cores included therein. Processor 602 may represent one or more general-purpose processors such as a microprocessor, a central processing unit (CPU), or the like. More particularly, processor 602 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 602 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 602, which may be a low power multi-core processor socket such as an ultra-low voltage processor, may act as a main processing unit and central hub for communication with the various components of the system. Such processor can be implemented as a system on chip (SoC). Processor 602 is configured to execute instructions for performing the operations and steps discussed herein. System 600 may further include a graphics interface that communicates with controller 606, which may include a display controller, a graphics processor, and/or a display device (e.g., an electronic display, a head up display, etc.).

Processor 602 may communicate with memory 604, which in one embodiment can be implemented via multiple memory devices to provide for a given amount of system memory. Memory 604 may include one or more volatile storage (or memory) devices such as random access memory (RAM), dynamic RAM (DRAM), synchronous DRAM (SDRAM), static RAM (SRAM), or other types of storage devices. Memory 606 may store information including sequences of instructions that are executed by processor 602, or any other device. For example, executable code and/or data of a variety of operating systems, device drivers, firmware (e.g., input output basic system or BIOS), and/or applications can be loaded in memory 606 and executed by processor 602. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 600 may further include IO devices such as, for example, network interface device(s) 608, optional input device(s) 610, and other optional IO device(s) 612. Network interface device 608 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 610 may include a mouse, a touch pad, a touch sensitive screen (which may be integrated with display device 606), a pointer device such as a stylus, and/or a keyboard (e.g., physical keyboard or a virtual keyboard displayed as part of a touch sensitive screen). For example, input device 612 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 610 may include an audio device. An audio device may include a speaker and/or a microphone to facilitate voice-enabled functions, such as voice recognition, voice replication, digital recording, and/or telephony functions. Other IO devices 612 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 612 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 618 via a sensor hub (not shown), while other devices such as a keyboard or thermal sensor may be controlled by an embedded controller (not shown), dependent upon the specific configuration or design of system 600.

To provide for persistent storage of information such as data, applications, one or more operating systems and so forth, a mass storage (not shown) may also couple to processor 602. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor(s) 602, e.g., via a serial peripheral interface (SPI). This flash device may provide for non-volatile storage of system software, including a basic input/output software (BIOS) as well as other firmware of the system.

Storage device 614 may include computer-accessible storage medium 616 (also known as a machine-readable storage medium or a computer-readable medium) on which is stored one or more sets of instructions or software (e.g., module, unit, and/or logic 620) embodying any one or more of the methodologies or functions described herein. Module/unit/logic 620 may also reside, completely or at least partially, within memory 604 and/or within processor 602 during execution thereof by data processing system 600, memory 604 and processor 602 also constituting machine-accessible storage media. Module/unit/logic 620 may further be transmitted or received over a network via network interface device 608.

Computer-readable storage medium 616 may also be used to store some software functionalities described above persistently. While computer-readable storage medium 616 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic 620, components and other features described herein can be implemented as discrete hardware components or integrated in the functionality of hardware components such as ASICS, FPGAs, DSPs or similar devices. In addition, module/unit/logic 620 can be implemented as firmware or functional circuitry within hardware devices. Further, module/unit/logic 620 can be implemented in any combination hardware devices and software components.

Logic 620 may include dynamic workflow engine 622. Source formula engine 622 may perform the operations described, such as the method of 200 or corresponding to that of dynamic workflow engine 128.

Note that while system 600 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components, or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method performed by a data processing system, comprising:
displaying a user interface that includes one or more controls for identifying one or more records of a remote data platform, for generating one or more conditions associated with the one or more records, and for generating an action that is associated with the one or more conditions;
receiving input through the user interface that identifies the one or more records and defines the one or more conditions and the action;
determining a user associated with the action;
sensing device activity of the user;
sensing the one or more records on the remote data platform for satisfaction of the one or more conditions; and
in response to sensing non-performance of the action and in response to sensing the one or more records on the remote data platform satisfy the one or more conditions, providing the action to the user.

2. The method of claim 1, wherein determining the user comprises searching one or more fields of the one or more records or metadata associated with the one or more records and finding an association of the user to the one or more records or receiving indication of the user from the input through the user interface.

3. The method of claim 1, wherein displaying the user interface comprises presenting selectable fields and selectable operators to generate the one or more conditions.

4. The method of claim 1, wherein presenting the one or more controls comprises determining one or more actions based on fields of the one or more records or metadata that is associated with the one or more records, and presenting the one or more controls for selecting the action among one or more actions to select from based on the one or more records.

5. The method of claim 1, wherein receiving the one or more conditions comprises receiving a machine executable script comprising a query into the one or more records.

6. The method of claim 1, wherein providing the action to the user comprises at least one of: displaying a first instruction or control to the user to send an email to send to a second user; displaying a second instruction or control to make a phone call to send to the second user; displaying a third instruction or control to connect with the second user over a social network; displaying a fourth instruction or control to send a short message service (SMS) message to the second user, or displaying a fifth instruction or control to send a message to the second user with a third party messaging platform.

7. The method of claim 6, wherein the second user is determined based on one or more fields or metadata of the one or more records or is indicated in the input through the user interface.

8. The method of claim 1, wherein sensing the device activity of the user comprises using one or more application plugins that sense operations associated with an email application, browser application, or a standalone application, to determine whether the action is performed by the user.

9. The method of claim 1, wherein in response to sensing that the action is performed by the user, refraining from providing the action to the user and storing in memory a second record that includes that the user performed the action prior to satisfaction of the one or more conditions.

10. The method of claim 1, wherein the one or more conditions comprise a trigger condition to begin sensing the one or more records on the remote data platform, and a time condition to perform the action within.

11. A computing apparatus comprising:
a processor; and
a memory storing instructions that, when executed by the processor, configure the apparatus to:
display a user interface that includes one or more controls for identifying one or more records of a remote data platform, for generating one or more conditions associated with the one or more records, and for generating an action that is associated with the one or more conditions;
receive input through the user interface that identifies the one or more records and defines the one or more conditions and the action;
determine a user associated with the action;
sense device activity of the user;
sense the one or more records on the remote data platform for satisfaction of the one or more conditions; and
in response to sensing non-performance of the action and in response to sensing the one or more records on the remote data platform satisfy the one or more conditions, provide the action to the user.

12. The computing apparatus of claim 11, wherein determining the user comprises search one or more fields of the one or more records or metadata associated with the one or more records and finding an association of the user to the one or more records, or receiving indication of the user from the input through the user interface.

13. The computing apparatus of claim 11, wherein displaying the user interface comprises present selectable fields and selectable operators to generate the one or more conditions.

14. The computing apparatus of claim 11, wherein presenting the one or more controls comprises determine one or more actions based on fields of the one or more records or metadata that is associated with the one or more records, and presenting the one or more controls for selecting the action among one or more actions to select from based on the one or more records.

15. The computing apparatus of claim 11, wherein receive the one or more conditions comprises receiving a machine executable script comprising a query into the one or more records.

16. A non-transitory computer-readable storage medium, the computer-readable storage medium including instructions that when executed by a computer, cause the computer to:
display a user interface that includes one or more controls for identifying one or more records of a remote data platform, for generating one or more conditions associated with the one or more records, and for generating an action that is associated with the one or more conditions;
receive input through the user interface that identifies the one or more records and defines the one or more conditions and the action;
determine a user associated with the action;
sense device activity of the user;
sense the one or more records on the remote data platform for satisfaction of the one or more conditions; and
in response to sensing non-performance of the action and in response to sensing the one or more records on the remote data platform satisfy the one or more conditions, provide the action to the user.

17. The computer-readable storage medium of claim 16, wherein determining the user comprises search one or more fields of the one or more records or metadata associated with the one or more records and finding an association of the user to the one or more records, or receiving indication of the user from the input through the user interface.

18. The computer-readable storage medium of claim 16, wherein displaying the user interface comprises present selectable fields and selectable operators to generate the one or more conditions.

19. The computer-readable storage medium of claim 16, wherein presenting the one or more controls comprises determine one or more actions based on fields of the one or more records or metadata that is associated with the one or more records, and presenting the one or more controls for selecting the action among one or more actions to select from based on the one or more records.

20. The computer-readable storage medium of claim 16, wherein receive the one or more conditions comprises receiving a machine executable script comprising a query into the one or more records.
